(19) United States
(12) Patent Application Publication
(10) Pub. No.: US 2001/0054260 A1
(43) Pub. Date: Dec. 27, 2001

(54) Patio screen door closer

(76) Inventors: Thomas S. Plum, Kamuela, HI (US); Lana L. Plum, Kamuela, HI (US)

Correspondence Address: NIXON & VANDERHYE P.C., 1100 North Glebe Road, 8th Floor, Arlington, VA, 22201-4714, US

(21) Appl. No.: 09/824,240

(22) Filed: Apr. 3, 2001

Related U.S. Application Data
(60) Provisional application No. 60/194,411, filed on Apr. 4, 2000.

(51) Int. Cl. E05F 1/00

(52) U.S. Cl. 49/447

(57) ABSTRACT

A cost-effective door-closing mechanism for sliding doors such as patio screens includes a connecting line attached at one end to the door and at the opposite end to a hanging weight. A pulley secured adjacent a closed side of the sliding door is disposed between the ends of the connecting line and receives the connecting line such that the hanging weight urges the sliding door closed. A protecting tube is disposed surrounding the pulley, hanging weight and connecting line.

This application claims the benefit of U.S. Provisional Patent Application Serial No. 60/194,411, filed Apr. 4, 2000, the entire content of which is herein incorporated by reference.

### BACKGROUND AND SUMMARY OF THE INVENTION

The present invention relates to components for sliding doors such as patio screen doors and the like and, more particularly, to a door-closing mechanism for sliding doors.

Sliding doors such as patio screen doors typically slide horizontally on tracks. The doors come in various widths, typically 3, 4 or 5 feet. In parts of the USA with mild climate (such as Hawaii), screen doors are often the only door in active use during a typical day.

Young children and memory-impaired elderly have difficulty remembering to close patio screen doors. Unlike hinged screen doors, there are no commercially-available door-closer mechanisms for sliding doors. In most localities where patio screens are common, their main purpose is to screen out flying insects. Patio screens left open can create an insect-pest problem.

The present invention provides a cost-effective door-closing mechanism for patio screens. The door closing mechanism includes a connecting line attachable at a first end to the sliding door. A hanging weight is attached to a second end of the connecting line. A pulley is securable adjacent a closed side of the sliding door and is sized to receive the connecting line such that the hanging weight urges the sliding door toward a closed position when the door-closing mechanism is installed. The door-closing mechanism may further include a protecting tube attachable adjacent the closed side of the sliding door. The protecting tube supports the pulley and encloses the hanging weight. The protecting tube is provided with a slot that is sized to receive and support a spindle that rotatable supports the pulley. Positioning tubes may be mounted on the spindle between the protecting tube and the pulley on each side of the pulley.

Preferably, the connecting line is formed of nylon. The hanging weight may be composed of a plurality of weight components that are selectively attachable to the second end of the connecting line according to a weight of the sliding door. These weight components are preferably lead weights or the like.

In accordance with another exemplary embodiment of the invention, a sliding door assembly includes a sliding door movable between a closed position and an open position, and the door-closing mechanism of the present invention. The door-closing mechanism cooperates with the sliding door to effect automatic closing of the sliding door. In one embodiment, the sliding door is a screen door.

In accordance with still another exemplary embodiment of the present invention, a door-closing mechanism is provided for a sliding door. The protecting tube of the mechanism includes a first slot therein that is sized to receive and support the spindle and a second slot therein disposed perpendicular to the first slot that receives the connecting line. An eyelet may be disposed in the second slot of the protecting tube, wherein the connecting line is threaded through the eyelet.

### BRIEF DESCRIPTION OF THE DRAWINGS

These and other aspects and advantages of the present invention will be described in detail with reference to the accompanying drawings, in which:

FIG. 1 illustrates a conventional patio door in the closed position in conjunction with an example embodiment of patio screen door closer according to the invention;

FIG. 2 illustrates a conventional patio door in the open position in conjunction with an example embodiment of patio screen door closer;

FIG. 3 is a side view of an example embodiment patio screen door closer; and

FIG. 4 is a sectional front view of an example embodiment patio screen door closer.

### DETAILED DESCRIPTION OF PREFERRED EMBODIMENTS

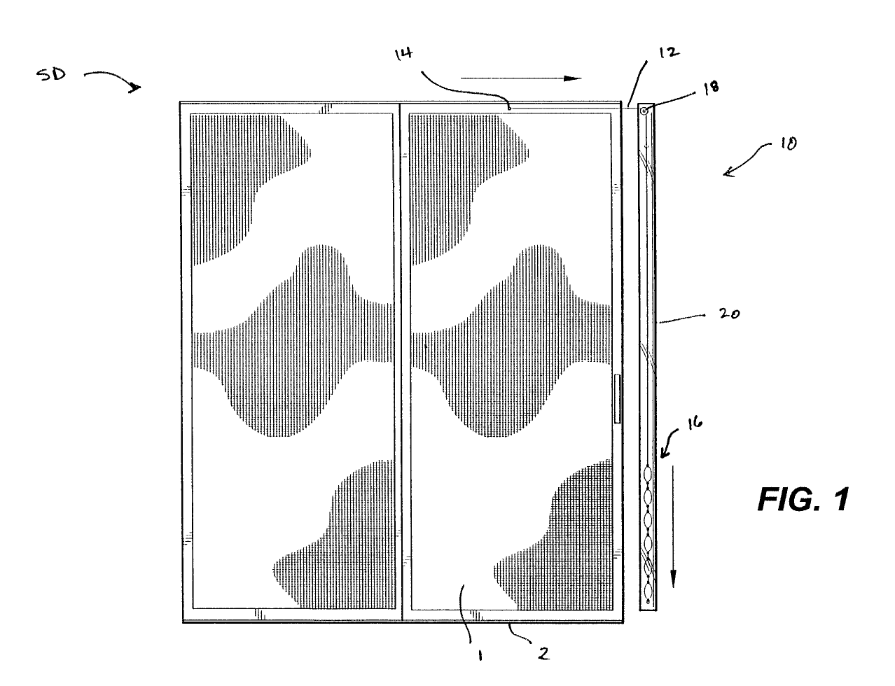

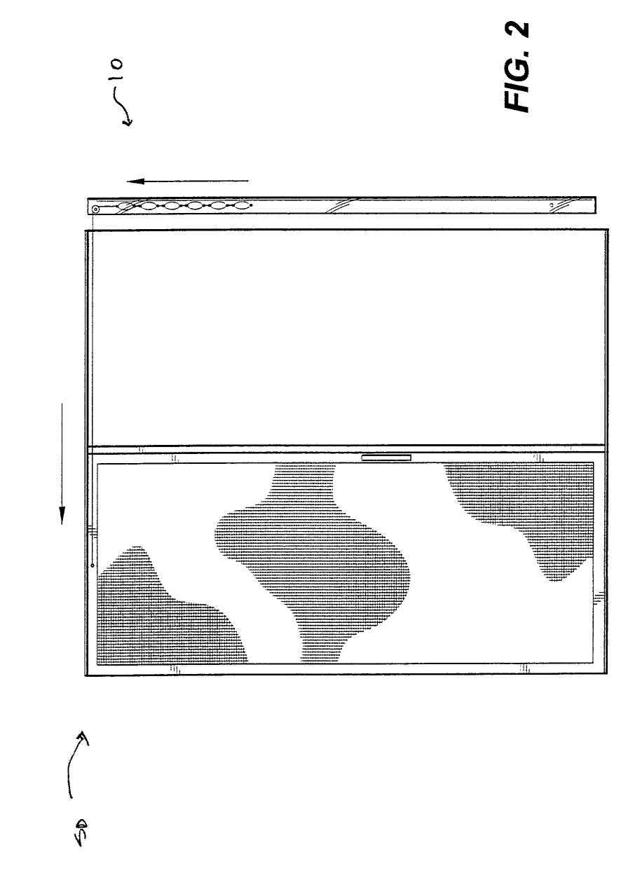

FIGS. 1 and 2 show a sliding door assembly SD of the screen type, wherein a movable door 1 slides horizontally on a track 2 between a closed position as shown in FIG. 1 and an open position as shown in FIG. 2. A door-closing mechanism 10 is coupled with the sliding door assembly SD to effect automatic closing of the screen door 1. Although the invention will be described in the context of sliding screen doors, it will be appreciated that the door-closing mechanism according to the present invention is applicable to any type of sliding door, and the invention is not meant to be limited to the illustrated application.

The door-closing mechanism 10 generally includes a connecting line 12 attached at a first end to the sliding door 1 via an eyelet, hook, peg or the like 14. The connecting line 12 is preferably formed of nylon or other suitably strong material that can withstand sudden pulls and the like. A hanging weight 16 is attached to a second end of the connecting line 12, and a pulley 18 is supported adjacent the sliding door assembly SD. The pulley 18 is sized to receive and support the connecting line 12 as shown in FIGS. 1 and 2. A protecting tube 20 encloses the pulley 18, connecting line 12 and hanging weight 16. The protecting tube 20 is preferably a transparent plastic tube or the like, similar to the plastic tube sold for protection of fluorescent bulbs. Of course, the tube 20 may alternatively be colored transparent, opaque, or any other suitable construction according to the user's design preference.

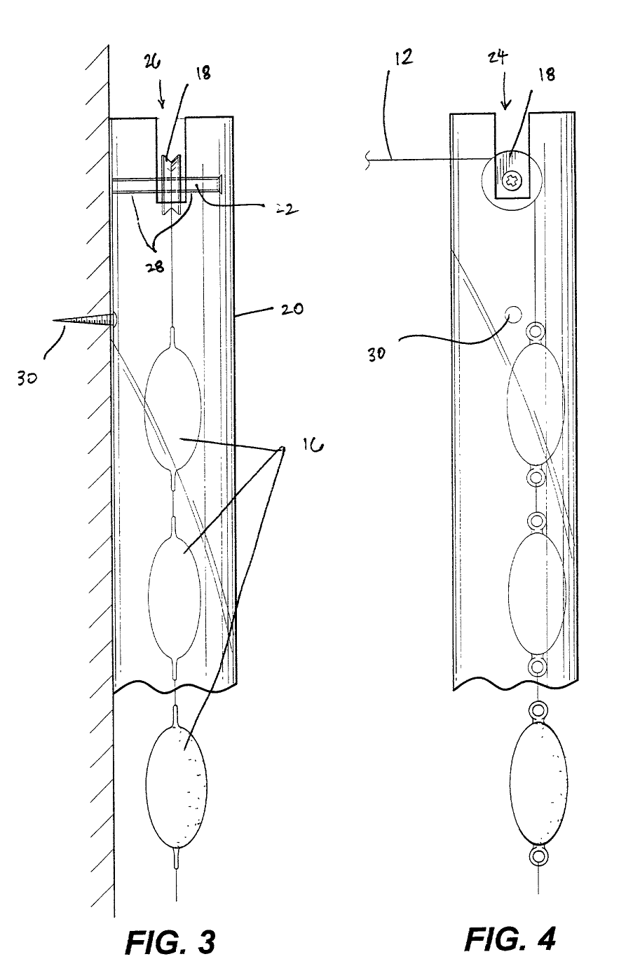

As shown in FIGS. 3 and 4, a spindle 22 of the pulley 18 rotatably supports the pulley 18 in the protecting tube 20. The protecting tube includes a first slot 24 that is sized to receive and support the spindle 22. The spindle 22 may be a screw that serves to support the protecting tube 20 on a wall. A second slot 26 formed substantially perpendicular to the first slot 24 is formed in the protecting tube 20 to receive the connecting line 12. A pair of positioning tubes 28 are mounted on the spindle 22 between the protecting tube 20 and the pulley 18 on each side of the pulley as shown in FIG. 3. The positioning tubes 28 serve to secure the pulley 18 in a steady position at the center of the interior diameter of the tube 20. An additional cylindrical sleeve may be provided to expand the diameter of the spindle 22 if necessary (for example, when the spindle 22 is a screw) to approximate the interior diameter of the pulley 18. A mounting screw 30 or the like secures the protecting tube 20 in the wall adjacent the enclosed side of the sliding door as shown in FIG. 1.

The hanging weight 16 is preferably a plurality of weight components or lead weights as shown in FIGS. 3 and 4. The weight components are selectively attachable to the second end of the connecting line 12 according to a weight of the sliding door. The amount of weight can be readily adjusted to a force sufficient to close the screen.

With continued reference to FIGS. 1 and 2, when the sliding screen door 1 is opened, the force applied by the person opening the door causes the connecting line 12 to raise the hanging weight 16 via the pulley 18. When the door 1 is released, the hanging weight 16 urges the connecting line 12 in the opposite direction, thereby automatically closing the door.

While the invention has been described in connection with what is presently considered to be the most practical and preferred embodiments, it is to be understood that the invention is not to be limited to the disclosed embodiments, but on the contrary, is intended to cover various modifications and equivalent arrangements.

What is claimed is:

1. A door-closing mechanism for a sliding door, the door-closing mechanism comprising:
a connecting line attachable at a first end to the sliding door;
a hanging weight attached to a second end of the connecting line; and
a pulley securable adjacent a closed side of the sliding door,
wherein the pulley is sized to receive the connecting line such that the hanging weight urges the sliding door toward a closed position when the door-closing mechanism is installed.

2. A door-closing mechanism according to claim 1, further comprising a protecting tube attachable adjacent the closed side of the sliding door, the protecting tube supporting the pulley and enclosing the hanging weight.

3. A door-closing mechanism according to claim 2, further comprising a spindle rotatably supporting the pulley, wherein the protecting tube comprises a slot therein that is sized to receive and support the spindle.

4. A door-closing mechanism according to claim 3, further comprising positioning tubes mounted on the spindle between the protecting tube and the pulley on each side of the pulley.

5. A door-closing mechanism according to claim 1, wherein the connecting line is formed of nylon.

6. A door-closing mechanism according to claim 1, wherein the hanging weight comprises a plurality of weight components, wherein the weight components are selectively attachable to the second end of the connecting line according to a weight of the sliding door.

7. A door-closing mechanism according to claim 6, wherein the weight components comprise lead weights.

8. A sliding door assembly comprising:
a sliding door movable between a closed position and an open position; and
a door-closing mechanism cooperating with the sliding door to effect automatic closing of the sliding door, the door-closing mechanism comprising:
a connecting line attached at a first end to the sliding door,
a hanging weight attached to a second end of the connecting line, and
a pulley secured adjacent a closed side of the sliding door, wherein the pulley is sized to receive the connecting line such that the hanging weight urges the sliding door toward a closed position.

9. A sliding door assembly according to claim 8, further comprising a protecting tube attached adjacent the closed side of the sliding door, the protecting tube supporting the pulley and enclosing the hanging weight.

10. A sliding door assembly according to claim 9, further comprising a spindle rotatably supporting the pulley, wherein the protecting tube comprises a slot therein that is sized to receive and support the spindle.

11. A sliding door assembly according to claim 10, further comprising positioning tubes mounted on the spindle between the protecting tube and the pulley on each side of the pulley.

12. A sliding door assembly according to claim 8, wherein the connecting line is formed of nylon.

13. A sliding door assembly according to claim 7, wherein the hanging weight comprises a plurality of weight components, wherein the weight components are selectively attachable to the second end of the connecting line according to a weight of the sliding door.

14. A sliding door assembly according to claim 13, wherein the weight components comprise lead weights.

15. A sliding door assembly according to claim 8, wherein the sliding door is a screen door.

16. A door-closing mechanism for a sliding door, the door-closing mechanism comprising:
a connecting line attachable at a first end to the sliding door;
a hanging weight attached to a second end of the connecting line;
a pulley securable adjacent a closed side of the sliding door, wherein the pulley is sized to receive the connecting line such that the hanging weight urges the sliding door toward a closed position when the door-closing mechanism is installed;
a spindle rotatably supporting the pulley; and
a protecting tube attachable adjacent the closed side of the of the sliding door, the protecting tube enclosing the pulley and hanging weight and comprising a first slot therein that is sized to receive and support the spindle and a second slot therein disposed perpendicular to the first slot, the second slot receiving the connecting line.

17. A door-closing mechanism according to claim 16, further comprising an eyelet disposed in the second slot of the protecting tube, wherein the connecting line is threaded through the eyelet.
